(19) United States
(12) Patent Application Publication
(10) Pub. No.: US 2009/0259397 A1
(43) Pub. Date: Oct. 15, 2009

(54) NAVIGATION SYSTEM WITH TOUCHPAD REMOTE

(76) Inventor: Richard Stanton, Auckland (NZ)

Correspondence Address: NORTH AMERICA INTELLECTUAL PROPERTY CORPORATION, P.O. BOX 506, MERRIFIELD, VA, 22116, US

(21) Appl. No.: 12/100,422

(22) Filed: Apr. 10, 2008

(51) Int. Cl. G01C 21/00

(52) U.S. Cl. 701/213

(57) ABSTRACT

To increase safety and convenience of use for navigation devices installed in automobiles, a navigation system includes the navigation device, a remote control, and a wired or wireless transceiver for establishing a data connection between the navigation device and the remote control. The navigation device has a housing, a display for displaying images, a GPS receiver for receiving GPS signals, and a processor coupled to the GPS receiver and the display for determining position according to the GPS signals and processing program code for controlling the display to display a graphical user interface. The remote control is external to the housing.

### BACKGROUND OF THE INVENTION

1. Field of the Invention

The present invention relates to navigation systems, and more particularly, to a navigation system with a touchpad remote.

2. Description of the Prior Art

A number of navigation methods have been employed over the centuries by sailors desiring to go from one place to another without getting lost on the way or passing through dangerous waters. Whereas in the past, navigation was typically of interest to navigators on marine vessels, as more advanced navigation systems are developed, drivers, hikers, and tourists are rapidly adopting Global Navigation Satellite System (GNSS) receivers as aids in their travels.

One key to navigation is positioning, or the art of knowing precisely where one is at any given moment. In the past, positioning was accomplished through use of a sextant, which measures angular positions of celestial bodies relative to the horizon. Today, positioning can be accomplished with fair accuracy by GNSS receivers. Currently, only the NAVSTAR Global Positioning System (GPS) developed by the United States Department of Defense offers comprehensive positioning satellite coverage around the globe, though other systems should become operational by the year 2010.

A typical GPS receiver will include an antenna for receiving electrical signals transmitted by GPS satellites, and positioning circuitry for determining a position of the GPS receiver from the electrical signals, and generating corresponding position data. The antenna can be integrated into the GPS receiver, or can be connected externally through a wire. A GPS device can integrate the GPS receiver and further means for providing functions that use the position data generated by the GPS receiver.

The GPS device will typically include an internal map, which can be used in conjunction with the position data to determine where the GPS device is located on the map. Based on this information, a navigator function of the GPS device can calculate a route along known roads from the position of the GPS device to another known location. The route can then be displayed on a display of the GPS device, and instructions on upcoming maneuvers can be displayed on the GPS device and played through a speaker of the GPS device to alert the user as to which maneuvers should be taken to reach their destination. As the GPS device travels along the route, the GPS device is also able to determine speed based on how far the GPS device travels over a period of time.

Please refer to FIG. 1, which is a diagram of a GPS device 120 installed in an automobile 100. As shown in FIG. 1, the GPS device 120 can be a standalone mobile device. The GPS device 120 could also be integrated into the automobile 100 as another instrument on a dashboard. The standalone mobile device 120 can be adapted for use in the automobile through a mount 130, which can be attached to the automobile through a suction cup, as shown attached to a windshield, or through other more permanent means.

One typical problem encountered when utilizing a configuration such as that shown in FIG. 1, wherein the GPS device 120 is mounted to the windshield, or integrated in the dashboard, is that a driver sitting in a driver's seat 140 of the automobile 100 cannot reach the GPS device 120 without posing a safety risk to the driver, any passengers, and other motor vehicles. Thus, if the driver wishes to access functions of the GPS device 120 while driving, the driver must reach over to press small buttons, watching both the GPS device 120 and the road. This could lead to an accident, and also is not practical for the driver to operate the GPS device 120. It could also be said that, assuming safe driving behavior, the driver is unable to operate the GPS device 120 while driving, which may limit the usefulness of the GPS device 120, which is supposed to be a driving aid.

### SUMMARY OF THE INVENTION

According to the present invention, a navigation system comprises a navigation device, a remote control, and means for establishing a data connection between the navigation device and the remote control. The navigation device comprises a housing, a display for displaying images, a GPS receiver for receiving GPS signals, and a processor coupled to the GPS receiver and the display for determining position according to the GPS signals and processing program code to control the display to display a graphical user interface. The remote control is external to the housing, and the means for establishing the data connection between the remote control and the navigation device are for sending an input signal from the remote control to the navigation device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a GPS device installed in an automobile.

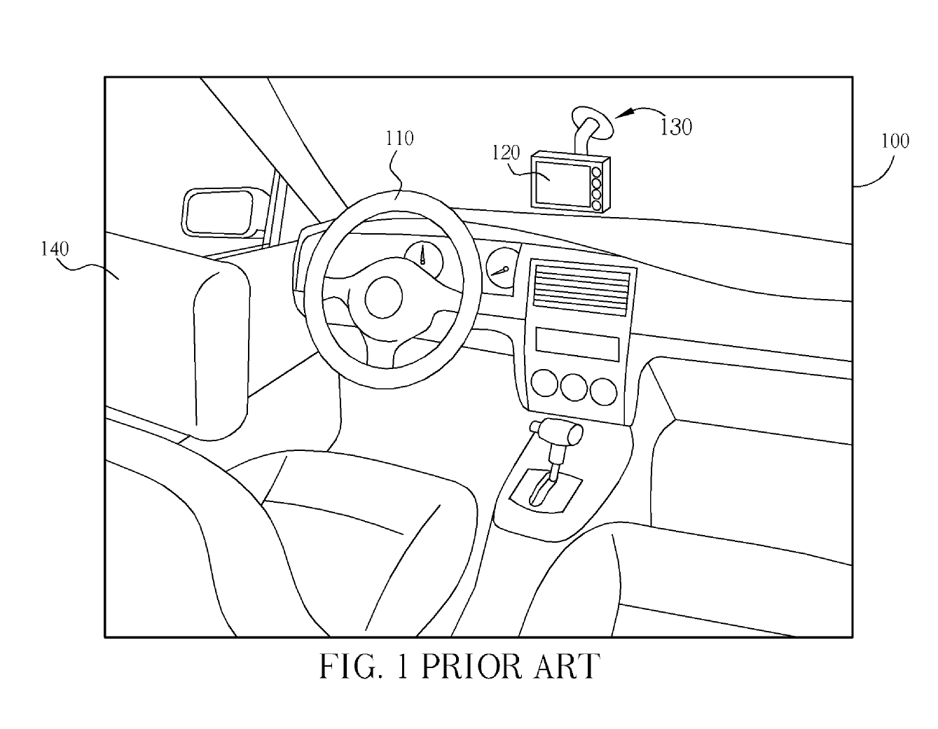

FIG. 2 is a diagram of a navigation system according to the present invention.

FIG. 3 is a diagram of a remote control of the navigation system of FIG. 2 installed in a steering wheel.

FIG. 4 is a table of inputs and corresponding commands for the navigation system according to the present invention.

### DETAILED DESCRIPTION

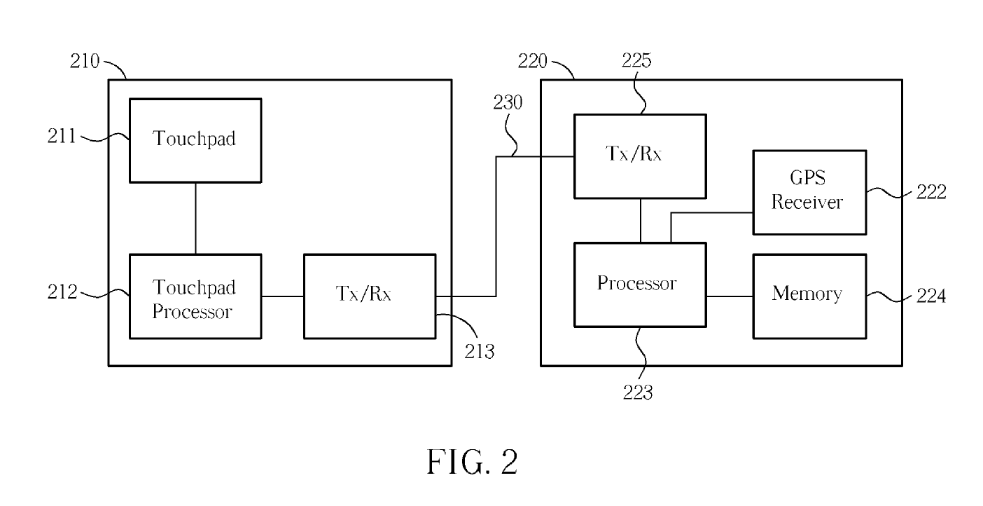

In order to allow the driver to drive defensively while accessing useful functions of the navigation device, the present invention discloses a navigation system shown in FIG. 2. The navigation system comprises a navigation device 220, a remote control 210, and means 230 for establishing a data connection between the remote control 210 and the navigation device 220. The navigation device 220 comprises a GPS receiver 222 for receiving GPS signals, and a processor 223 coupled to the GPS receiver 222 for determining position according to the GPS signals and processing program code stored in a memory 224 to control a display to display a graphical user interface. The display may show the graphical user interface (GUI), a map, a position on the map, a route along streets of the map, and other types of information. The navigation device 220 also comprises a transceiver 225, which can be utilized to send and receive data packets to and from other devices.

The remote control 210 may comprise a touchpad 211 for receiving touch inputs, and a touchpad processor 212 for processing the touch inputs. The touchpad may be strictly an input device, or the touchpad may display images. The remote control 210 may be mounted in a steering wheel of an automobile, in an armrest of a driver's seat, or in a center column between the driver's seat and a passenger seat. In each case, the remote control 210 would be easily accessible to the user. In addition to the touchpad 211, the remote control 210 may also comprise a button, or buttons, corresponding to functions of the navigation device 220. The button or buttons could be customizable, i.e. the user could map the buttons to functions of the navigation device 220 depending on their requirements. The remote control 210 may also comprise other types of input mechanisms, such as a roller button, a trackball, a joystick, etc. The remote control 210 may receive user inputs, and generate a corresponding input signal, which may be sent to the navigation device 220.

The navigation system further comprises means 230 for establishing a data connection between the remote control 210 and the navigation device 220 for sending the input signal mentioned above to the navigation device 220. The remote control 210, like the navigation device 220, may further comprise a transceiver 213 for sending and receiving data to and from another device, such as the navigation device 220. The means 230 for establishing the data connection between the remote control 210 and the navigation device 220 could comprise a cable or wire, or a wireless connection. The cable could be a serial cable, a universal serial bus (USB) cable, or another type of data cable. On the other hand, if the data connection were the wireless connection, then the means 230 could be a Bluetooth connection, wherein the transceiver 225 of the navigation device and the transceiver 213 of the navigation device both conform to the Bluetooth standard, and can be paired to each other. The means 230 could also be an 802.11-type wireless connection, or any other type of radio frequency (RF) connection. Use of the wireless connection would make the navigation system much easier to implement in the automobile, as installation would not require running the cable from the steering wheel, the armrest, or the column to a dedicated port, or to the navigation device 220 directly if the navigation device 220 were built into the dashboard of the automobile. Instead, by using the wireless connection, the remote control 210 and the navigation device 220 could be paired, and no wiring would be required.

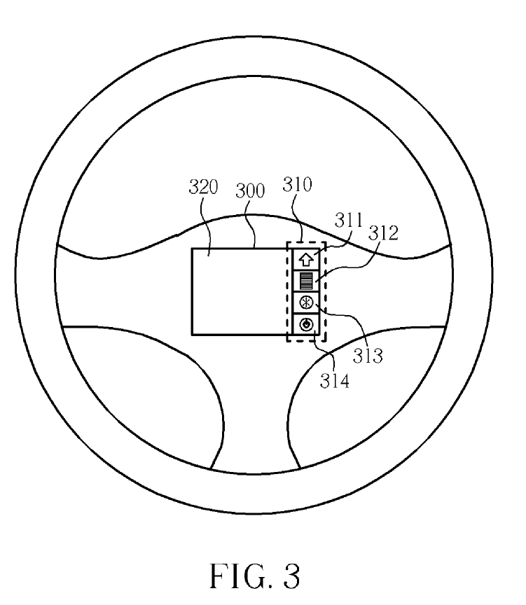

Please refer to FIG. 3, which is a diagram of a remote control 300 installed in a steering wheel. The remote control 300 can be considered a practical implementation of the remote control 210 shown in FIG. 2. The remote control 300 comprises a button region 310 and a gesture input region 320. As mentioned above, the remote control 300 could be implemented completely as a touchpad, or the remote control 300 could be implemented as a touchpad with display capability. The button region 310 comprises a home region 311 for commanding the navigation device 220 to navigate a route to a predetermined home address. The button region 310 also comprises a menu region 312 for commanding the navigation device 220 to display a menu. The button region 310 further comprises an establish link region 313 for activating or deactivating the wireless connection between the remote control 300 and the navigation device 220. Finally, the button region 310 may also comprise a power region for turning the remote control 300 on or off. Other button regions are also available, such as a push-to-talk region for activating a push-to-talk function, which could take a voice input from a microphone installed in either the remote control 300 or the navigation device 220. A search button region could also be included to allow the user to utilize the gesture input region 320 to input a string for search in the navigation device 220. The button region 310 could be implemented as a graphic display if the touchpad 211 were capable of displaying images, else the button region 310 could be implemented with standard buttons.

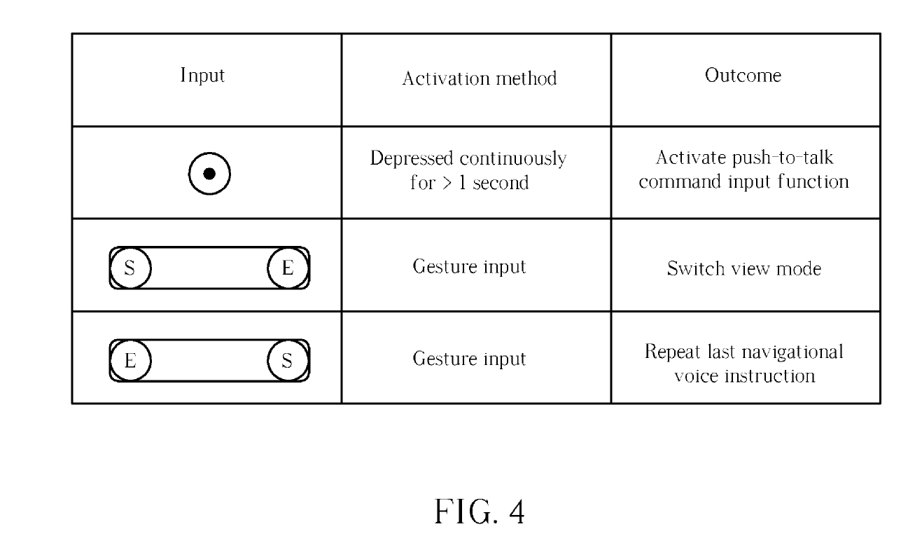

The gesture input region 320 may be utilized to input various types of gesture inputs, such as combinations of points, lines, and curves. Please refer to FIG. 4, which is a table of various possible gesture inputs as applied to the present invention navigation system. If the user were to depress a single point for at least one second anywhere on the gesture input region 320 of the remote control 300, the push-to-talk function could be activated. Or, if the user were to make a straight line from left to right on the gesture input region 320, a view mode of the navigation device 220 could be switched, for example from displaying a navigational map to displaying an input menu. Finally, if the user were to make a straight line from right to left, the navigation device 220 could be commanded to repeat a last navigational voice instruction. Of course, these various types of inputs, and other types of gesture inputs, could be customized by the user, or could be preset in the remote control 300. For example, the gesture input may be a circle drawn clockwise or counterclockwise from any point along a circumference of the circle, e.g. a top of the circle or a bottom of the circle. Also, the gesture input may be a question mark, which may correspond to a help function. Of course, other shapes and symbols may also be utilized by the present invention.

In summary, the present invention makes controlling the navigation device 220 while driving more convenient and safe through addition of the remote control 210 (or 300) and the means 230 for establishing the data connection between the remote control 210 and the navigation device 220. The remote control 210 can be installed conveniently in the steering wheel, armrest, or center column of the automobile, providing quick access, without requiring line of sight, to many commands and functions of the navigation device 220. This increases safety, and also makes it easier for the user to access the navigation device 220 whether driving or at a stop, without having to remove their seatbelt, or reach to find small buttons on the navigation device 220 itself.

Those skilled in the art will readily observe that numerous modifications and alterations of the device and method may be made while retaining the teachings of the invention.

What is claimed is:

1. A navigation device comprising:
a navigation device comprising:
a housing;
a display for displaying images;
a GPS receiver for receiving GPS signals; and
a processor installed in the housing coupled to the GPS receiver and the display for determining position according to the GPS signals and processing program code for controlling the display to display a user interface;
a remote control external to the housing of the navigation device for generating an input signal corresponding to a user input; and
means for establishing a data connection between the remote control and the navigation device for sending the input signal to the navigation device.

2. The navigation system of claim 1, wherein the remote control comprises:
a touchpad for generating a touchpad input signal; and
a touchpad processor for converting the touchpad input signal into the input signal.

3. The navigation system of claim 2, wherein the touchpad comprises:
a button region corresponding to a predetermined function of the navigation device.

4. The navigation system of claim 3, wherein the button region comprises a push-to-talk region for controlling the navigation device to receive voice signals while the push-to-talk region is activated.

5. The navigation system of claim 3, wherein the button region comprises a home region for controlling the navigation device to determine a route to a preset home position.

6. The navigation system of claim 3, wherein the button region comprises a menu region for controlling the navigation device to display a menu in the display.

7. The navigation system of claim 3, wherein the button region comprises a search region for activating a search function of the navigation device.

8. The navigation system of claim 3, wherein the button region comprises an establish link region for establishing a wireless data connection between the remote control and the navigation device.

9. The navigation system of claim 2, wherein the touchpad comprises:
a gesture input region for receiving a gesture input corresponding to a predetermined function of the navigation device.

10. The navigation system of claim 2, wherein the touchpad comprises a display for displaying a graphical user interface in the touchpad.

11. The navigation system of claim 1, wherein the means for establishing the data connection between the remote control and the navigation device comprises a cable.

12. The navigation system of claim 11, wherein the cable is a serial cable.

13. The navigation system of claim 11, wherein the cable is a universal serial bus (USB) cable.

14. The navigation system of claim 1, wherein the means for establishing the data connection between the remote control and the navigation device comprises a first wireless transceiver installed in the housing coupled to the processor, and a second wireless transceiver installed in the remote control.

15. The navigation system of claim 14, wherein the first wireless transceiver is a Bluetooth transceiver.

16. The navigation system of claim 14, wherein the first wireless transceiver is an 802.11-series transceiver.

17. The navigation system of claim 14, wherein the first wireless transceiver is a radio frequency (RF) transceiver.

18. The navigation system of claim 14, wherein the first wireless transceiver is an infrared transceiver.

19. The navigation system of claim 1, wherein the remote control is mounted in a steering wheel.

20. The navigation system of claim 1, wherein the remote control is mounted in an armrest.
